(19) United States
(12) Patent Application Publication
(10) Pub. No.: US 2024/0182672 A1
(43) Pub. Date: Jun. 6, 2024

(54) FILLER COMPOSITION, COMPOSITE MATERIAL AND COMPOSITE MATERIAL LAYER WITH THERMAL BARRIER PROPERTIES

(71) Applicant: SAINT-GOBAIN PERFORMANCE PLASTICS CORPORATION, Solon, OH (US)

(72) Inventors: Yangdi LI, Shanghai (CN); Shifang ZHAO, Shanghai City (CN); Yue DONG, Shanghai (CN)

(21) Appl. No.: 18/524,375

(22) Filed: Nov. 30, 2023

Related U.S. Application Data
(60) Provisional application No. 63/477,588, filed on Dec. 29, 2022.

(30) Foreign Application Priority Data
Dec. 2, 2022 (CN) 202211543290.5

(51) Int. Cl. C08K 3/20; C08K 3/013

(52) U.S. Cl. CPC C08K 3/20; C08K 3/013; C08K 2201/014; H01M 50/383

(57) ABSTRACT

The subject application relates to a filler composition, composite material and composite material layer with thermal barrier properties. The present disclosure relates to a filler composition may include a ceramization filler component at a content of at least about 50 wt. % and not greater than about 90 wt. % for a total weight of the filler composition, a reinforcement component at a content of at least about 0.1 wt. % and not greater than about 10.0 wt. % for a total weight of the filler composition, a flux component at a content of at least about 3.0 wt. % and not greater than about 10.0 wt. % for a total weight of the filler composition, and a flame retardant component at least about 5.0 wt. % and not greater than about 20.0 wt. % for a total weight of the filler composition.

### CROSS-REFERENCE TO RELATED APPLICATION(S)

This application claims priority to Chinese Patent Application No. 202211543290.5, entitled “FILLER COMPOSITION, COMPOSITE MATERIAL AND COMPOSITE MATERIAL LAYER WITH THERMAL BARRIER PROPERTIES,” by Yangdi LI et al., filed Dec. 2, 2022, which is assigned to the current assignee hereof and is incorporated herein by reference in its entirety. This application further claims priority under 35 U.S.C. § 119(c) to U.S. Provisional Patent Application No. 63/477,588, entitled “FILLER COMPOSITION, COMPOSITE MATERIAL AND COMPOSITE MATERIAL LAYER WITH THERMAL BARRIER PROPERTIES,” by Yangdi LI et al., filed Dec. 29, 2022, which is assigned to the current assignee hereof and is incorporated herein by reference in its entirety.

### FIELD OF THE DISCLOSURE

The present disclosure relates to a filler composition, composite material and composite material layer and, in particular, a filler composition, composite material, and composite material layer for use as a thermal barrier in various applications, for example, in a battery pack, and methods of forming the same.

### BACKGROUND

Filler compositions, composite materials, and composite material layers may be designed for high temperature protection in various applications, for example, for use as thermal barriers in electric vehicle battery packs, thermal barrier coverings in high temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a filler composition may include a ceramization filler component at a content of at least about 50 wt. % and not greater than about 90 wt. % for a total weight of the filler composition, a reinforcement component at a content of at least about 0.1 wt. % and not greater than about 10.0 wt. % for a total weight of the filler composition, a flux component at a content of at least about 3.0 wt. % and not greater than about 10.0 wt. % for a total weight of the filler composition, and a flame retardant component at least about 5.0 wt. % and not greater than about 20.0 wt. % for a total weight of the filler composition.

According to yet another aspect, a composite material may include a polymer-based matrix component, and a filler composition distributed within the polymer-based component. The filler composition may include a ceramization filler component, a reinforcement component, a flux component, and a flame retardant component.

According to still another aspect, a composite material layer may include a polymer-based matrix component, and a filler composition distributed within the polymer-based component. The filler composition may include a ceramization filler component, a reinforcement component, a flux component, and a flame retardant component.

### BRIEF DESCRIPTION OF THE DRAWINGS

Embodiments are illustrated by way of example and are not limited to the accompanying FIGURES.

FIG. 1 includes an illustration of an example composite material according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a filler composition, a composite material that may include the filler composition, or a composite material layer that may include the filler composition.

Referring first to embodiments of the filler composition, the filler composition may include a ceramization filler component, a reinforcement component, a flux component, and a flame retardant component.

According to particular embodiments, the ceramization filler component may include particular components. For example, the ceramization filler component may include a component selected from the group consisting of aluminum silicate, zirconium silicate, zirconia, alumina, or any combination thereof. According to still other embodiments, the ceramization filler component may include aluminum silicate. According to yet other embodiments, the ceramization filler component may consist of aluminum silicate. According to still other embodiments, the ceramization filler component may include zirconium silicate. According to yet other embodiments, the ceramization filler component may consist of zirconium silicate. According to still other embodiments, the ceramization filler component may include zirconia. According to yet other embodiments, the ceramization filler component may consist of zirconia. According to still other embodiments, the ceramization filler component may include alumina. According to yet other embodiments, the ceramization filler component may consist of alumina.

According to still other embodiments, the filler composition may include a particular content of the ceramization filler component. For example, the filler composition may include a ceramization filler component content of at least about 50 wt. % for a total weight of the filler composition, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the filler composition may include a ceramization filler component content of not greater than about 90 wt. % for a total weight of the filler composition, such as, not greater than about 89 wt. % or not greater than about 88 wt. % or not greater than about 87 wt. % or not greater than about 86 wt. % or not greater than about 85 wt. % or not greater than about 84 wt. % or not greater than about 83 wt. % or not greater than about 82 wt. % or not greater than about 81 wt. % or even not greater than about 80 wt. %. It will be appreciated that filler composition may include a ceramization filler component content of any value within a range between any of the minimum and maximum values noted above. It will be further appreciated that the filler composition may include a ceramization filler component content of any value between any of the minimum and maximum values noted above.

According to particular embodiments, the reinforcement component may include particular components. According to particular embodiments, the reinforcement component may include wollastonite. According to yet other embodiments, the reinforcement component may consist of wollastonite.

According to still other embodiments, the filler composition may include a particular content of the reinforcement component. For example, the filler composition may include a reinforcement component content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a reinforcement component content of not greater than about 10.0 wt. % for a total weight of the filler composition, such as, not greater than about 9.5 wt. % or not greater than about 9.0 wt. % or not greater than about 8.5 wt. % or not greater than about 8.0 wt. % or not greater than about 7.5 wt. % or even not greater than about 7.0 wt. %. It will be appreciated that filler composition may include a reinforcement component content of any value within a range between any of the minimum and maximum values noted above. It will be further appreciated that the filler composition may include a structure promoter component content of any value between any of the minimum and maximum values noted above.

According to particular embodiments, the flux component may include particular components. For example, the flux component may include a component selected from the group consisting of low T glass frit, zinc oxide, zinc borate, antimony (III) oxide, bismuth (III) oxide, or any combination thereof. According to still other embodiments, the flux component may include low T glass frit. According to yet other embodiments, the flux component may consist of low T glass frit. According to still other embodiments, the flux component may include zinc oxide. According to yet other embodiments, the flux component may consist of zinc oxide. According to still other embodiments, the flux component may include zinc borate. According to yet other embodiments, the flux component may consist of zinc borate. According to still other embodiments, the flux component may include antimony (III) oxide. According to yet other embodiments, the flux component may consist of antimony (III) oxide. According to still other embodiments, the flux component may include bismuth (III) oxide. According to yet other embodiments, the flux component may consist of bismuth (III) oxide.

According to still other embodiments, the filler composition may include a particular content of the flux component. For example, the filler composition may include a flux component content of at least about 3.0 wt. % for a total weight of the filler composition, such as, at least about 3.5 wt. % or at least about 4.0 wt. % or at least about 4.5 wt. % or at least about 5.0 wt. % or at least about 5.5 wt. % or at least about 6.0 wt. % or even at least about 6.5 wt. %. According to still other embodiments, the filler composition may include a flux component content of not greater than about 10.0 wt. % for a total weight of the filler composition, such as, not greater than about 9.5 wt. % or not greater than about 8.0 wt. % or not greater than about 7.5 wt. % or even not greater than about 7.0 wt. %. It will be appreciated that filler composition may include a flux component content of any value within a range between any of the minimum and maximum values noted above. It will be further appreciated that the filler composition may include a flux component content of any value between any of the minimum and maximum values noted above.

According to particular embodiments, the flame retardant component may include particular components. For example, the flame retardant component may include a component selected from the group consisting of aluminum hydroxide, magnesium hydroxide, or any combination thereof. According to still other embodiments, the flame retardant component may include aluminum hydroxide. According to yet other embodiments, the flame retardant component may consist of aluminum hydroxide. According to still other embodiments, the flame retardant component may include magnesium hydroxide. According to yet other embodiments, the flame retardant component may consist of magnesium hydroxide.

According to still other embodiments, the filler composition may include a particular content of the flame retardant component. For example, the filler composition may include a flame retardant component content of at least about 5.0 wt. % for a total weight of the filler composition, such as, at least about 6.0 wt. % or at least about 7.0 wt. % or at least about 8.0 wt. % or at least about 9.0 wt. % or at least about 10.0 wt. % or at least about 11.0 wt. % or even at least about 12.0 wt. %. According to still other embodiments, the filler composition may include a flame retardant component content of not greater than about 20.0 wt. % for a total weight of the filler composition, such as, not greater than about 19.0 wt. % or not greater than about 18.0 wt. % or not greater than about 17.0 wt. % or not greater than about 16.0 wt. % or not greater than about 15.0 wt. % or even not greater than about 14.0 wt. %. It will be appreciated that filler composition may include a flame retardant component content of any value within a range between any of the minimum and maximum values noted above. It will be further appreciated that the filler composition may include a flame retardant component content of any value between any of the minimum and maximum values noted above.

According to still other embodiments, the filler composition may further include a functional additive. According to yet other embodiments, the functional additive may include a particular component. For example, the functional additive may include a component selected from the group consisting of iron (III) oxide, titanium oxide, or any combination thereof. According to still other embodiments, the functional additive component may include iron (III) oxide. According to yet other embodiments, the functional additive component may consist of iron (III) oxide. According to still other embodiments, the functional additive component may include titanium oxide. According to yet other embodiments, the functional additive component may consist of titanium oxide.

According to still other embodiments, the filler composition may include a particular content of the functional additive. For example, the filler composition may include a functional additive content of at least about 0.1 wt. % for a total weight of the filler composition, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition may include a functional additive content of not greater than about 7.0 wt. % for a total weight of the filler composition, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition may include a functional additive content of any value within a range between any of the minimum and maximum values noted above. It will be further appreciated that the filler composition may include a functional additive content of any value between any of the minimum and maximum values noted above.

Referring now to embodiments of the composite material, the composite material may include a polymer-based matrix component, and a filler composition distributed within the polymer-based matrix.

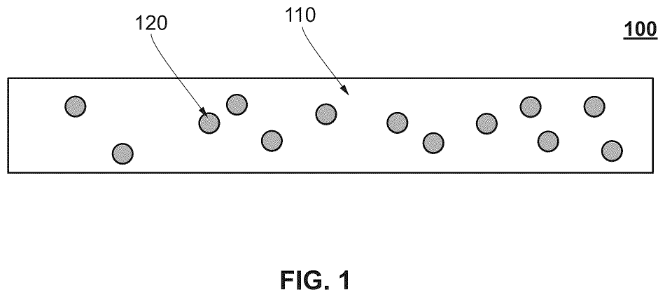

For purposes of illustration, FIG. 1 shows a composite material 100 according to embodiments described herein. As shown in FIG. 1, a composite material 100 may include a polymer-based matrix component 110, and a filler composition 120 distributed within the polymer-based matrix component 110.

According to particular embodiments, the polymer-based matrix component 110 of the composite material 100 may include a particular material. For example, the polymer-based matrix component 110 may include a component selected from the group consisting of silicone, polyurethane, epoxy, acrylic resin or any combination thereof. According to still other embodiments, the polymer based matrix component 110 may include silicone. According to yet other embodiments, the polymer based matrix component 110 may consist of silicone. According to still other embodiments, the polymer based matrix component 110 may include polyurethane. According to yet other embodiments, the polymer based matrix component 110 may consist of polyurethane. According to still other embodiments, the polymer based matrix component 110 may include epoxy. According to yet other embodiments, the polymer based matrix component 110 may consist of epoxy. According to still other embodiments, the polymer based matrix component 110 may include acrylic resin. According to yet other embodiments, the polymer based matrix component 110 may consist of acrylic resin.

According to still other embodiments, the composite material 100 may include a particular content of the polymer based matrix component 110. For example, the composite material 100 may include a polymer based matrix component content of at least about 30 wt. % for a total weight of the composite material 100, such as, at least about 33 wt. % or at least about 35 wt. % or at least about 38 wt. % or at least about 40 wt. % or at least about 43 wt. % or at least about 45 wt. % or even at least about 48 wt. %. According to still other embodiments, the composite material 100 may include a polymer based matrix component content of not greater than about 60 wt. % for a total weight of the composite material 100, such as, not greater than about 58 wt. % or not greater than about 55 wt. % or not greater than about 53 wt. % or even not greater than about 50 wt. %. It will be appreciated that composite material 100 may include a polymer based matrix component content of any value within a range between any of the minimum and maximum values noted above. It will be further appreciated that the composite material 100 may include a polymer based matrix component content of any value between any of the minimum and maximum values noted above.

According to still other embodiments, the composite material 100 may include a particular content of the filler composition 120. For example, the composite material 100 may include a filler composition content of at least about 40 wt. % for a total weight of the composite material 100, such as, at least about 43 wt. % or at least about 45 wt. % or at least about 48 wt. % or at least about 50 wt. % or at least about 53 wt. % or at least about 55 wt. % or even at least about 58 wt. %. According to still other embodiments, the composite material 100 may include a filler composition content of not greater than about 70 wt. % for a total weight of the composite material 100, such as, not greater than about 68 wt. % or not greater than about 65 wt. % or not greater than about 63 wt. % or even not greater than about 60 wt. %. It will be appreciated that composite material 100 may include a filler composition content of any value within a range between any of the minimum and maximum values noted above. It will be further appreciated that the composite material 100 may include a filler composition content of any value between any of the minimum and maximum values noted above.

According to certain embodiments, the filler composition 120 may include a ceramization filler component, a reinforcement component, a flux component, and a flame retardant component.

According to particular embodiments, the ceramization filler component of the filler composition 120 may include particular components. For example, the ceramization filler component may include a component selected from the group consisting of aluminum silicate, zirconium silicate, zirconia, alumina, or any combination thereof. According to still other embodiments, the ceramization filler component may include aluminum silicate. According to yet other embodiments, the ceramization filler component may consist of aluminum silicate. According to still other embodiments, the ceramization filler component may include zirconium silicate. According to yet other embodiments, the ceramization filler component may consist of zirconium silicate. According to still other embodiments, the ceramization filler component may include zirconia. According to yet other embodiments, the ceramization filler component may consist of zirconia. According to still other embodiments, the ceramization filler component may include alumina. According to yet other embodiments, the ceramization filler component may consist of alumina.

According to still other embodiments, the filler composition 120 may include a particular content of the ceramization filler component. For example, the filler composition 120 may include a ceramization filler component content of at least about 50 wt. % for a total weight of the filler composition 120, such as, at least about 53 wt. % or at least about 55 wt. % or at least about 58 wt. % or at least about 60 wt. % or at least about 63 wt. % or at least about 65 wt. % or at least about 68 wt. % or at least about 70 wt. % or at least about 73 wt. % or even at least about 75 wt. %. According to still other embodiments, the filler composition 120 may include a ceramization filler component content of not greater than about 90 wt. % for a total weight of the filler composition 120, such as, not greater than about 89 wt. % or not greater than about 88 wt. % or not greater than about 87 wt. % or not greater than about 86 wt. % or not greater than about 85 wt. % or not greater than about 84 wt. % or not greater than about 83 wt. % or not greater than about 82 wt. % or not greater than about 81 wt. % or even not greater than about 80 wt. %. It will be appreciated that filler composition 120 may include a ceramization filler component content of any value within a range between any of the minimum and maximum values noted above. It will be further appreciated that the filler composition 120 may include a ceramization filler component content of any value between any of the minimum and maximum values noted above.

According to still other embodiments, the composite material 100 may include a particular content of the ceramization filler component. For example, the composite material 100 may include a ceramization filler component content of at least about 25 wt. % for a total weight of the composite material 100, such as, at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or even at least about 35 wt. %. According to still other embodiments, the composite material 100 may include a ceramization filler component content of not greater than about 65 wt. % for a total weight of the composite material 100, such as, not greater than about 64 wt. % or not greater than about 68 wt. % or not greater than about 63 wt. % or not greater than about 62 wt. % or not greater than about 61 wt. % or not greater than about 60 wt. % or not greater than about 59 wt. % or not greater than about 58 wt. % or not greater than about 57 wt. % or even not greater than about 56 wt. %. It will be appreciated that composite material 100 may include a ceramization filler component content of any value within a range between any of the minimum and maximum values noted above. It will be further appreciated that the composite material 100 may include a ceramization filler component content of any value between any of the minimum and maximum values noted above.

According to particular embodiments, the reinforcement component of the filler composition 120 may include particular components. According to certain embodiments, the reinforcement component may include wollastonite. According to yet other embodiments, the reinforcement component may consist of wollastonite.

According to still other embodiments, the filler composition 120 may include a particular content of the reinforcement component. For example, the filler composition 120 may include a reinforcement component content of at least about 0.1 wt. % for a total weight of the filler composition 120, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition 120 may include a reinforcement component content of not greater than about 10.0 wt. % for a total weight of the filler composition 120, such as, not greater than about 9.5 wt. % or not greater than about 9.0 wt. % or not greater than about 8.5 wt. % or not greater than about 8.0 wt. % or not greater than about 7.5 wt. % or even not greater than about 7.0 wt. %. It will be appreciated that filler composition 120 may include a reinforcement component content of any value within a range between any of the minimum and maximum values noted above. It will be further appreciated that the filler composition 120 may include a reinforcement component content of any value between any of the minimum and maximum values noted above.

According to still other embodiments, the composite material 100 may include a particular content of the reinforcement component. For example, the composite material 100 may include a reinforcement component content of at least about 0.05 wt. % for a total weight of the composite material 100, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the composite material 100 may include a reinforcement component content of not greater than about 9.0 wt. % for a total weight of the composite material 100, such as, not greater than about 8.5 wt. % or not greater than about 8.0 wt. % or not greater than about 7.5 wt. % or even not greater than about 6.0 wt. %. It will be appreciated that composite material 100 may include a reinforcement component content of any value within a range between any of the minimum and maximum values noted above. It will be further appreciated that the composite material 100 may include a reinforcement component content of any value between any of the minimum and maximum values noted above.

According to particular embodiments, the flux component of the filler composition 120 may include particular components. For example, the flux component may include a component selected from the group consisting of low T glass frit, zinc oxide, zinc borate, antimony (III) oxide, bismuth (III) oxide, or any combination thereof. According to still other embodiments, the flux component may include low T glass frit. According to yet other embodiments, the flux component may consist of low T glass frit. According to still other embodiments, the flux component may include zinc oxide. According to yet other embodiments, the flux component may consist of zinc oxide. According to still other embodiments, the flux component may include zinc borate. According to yet other embodiments, the flux component may consist of zinc borate. According to still other embodiments, the flux component may include antimony (III) oxide. According to yet other embodiments, the flux component may consist of antimony (III) oxide. According to still other embodiments, the flux component may include bismuth (III) oxide. According to yet other embodiments, the flux component may consist of bismuth (III) oxide.

According to still other embodiments, the filler composition 120 may include a particular content of the flux component. For example, the filler composition 120 may include a flux component content of at least about 3.0 wt. % for a total weight of the filler composition 120, such as, at least about 3.5 wt. % or at least about 4.0 wt. % or at least about 4.5 wt. % or at least about 5.0 wt. % or at least about 5.5 wt. % or at least about 6.0 wt. % or even at least about 6.5 wt. %. According to still other embodiments, the filler composition 120 may include a flux component content of not greater than about 10.0 wt. % for a total weight of the filler composition 120, such as, not greater than about 9.5 wt. % or not greater than about 8.0 wt. % or not greater than about 7.5 wt. % or even not greater than about 7.0 wt. %. It will be appreciated that filler composition 120 may include a flux component content of any value within a range between any of the minimum and maximum values noted above. It will be further appreciated that the filler composition 120 may include a flux component content of any value between any of the minimum and maximum values noted above.

According to still other embodiments, the composite material 100 may include a particular content of the flux component. For example, the composite material 100 may include a flux component content of at least about 1.5 wt. % for a total weight of the composite material 100, such as, at least about 1.6 wt. % or at least about 1.7 wt. % or at least about 1.8 wt. % or at least about 1.9 wt. % or at least about 2.0 wt. % or even at least about 2.5 wt. %. According to still other embodiments, the composite material 100 may include a flux component content of not greater than about 9.0 wt. % for a total weight of the composite material 100, such as, not greater than about 8.5 wt. % or not greater than about 8.0 wt. % or not greater than about 7.5 wt. % or even not greater than about 7.0 wt. %. It will be appreciated that composite material 100 may include a flux component content of any value within a range between any of the minimum and maximum values noted above. It will be further appreciated that the composite material 100 may include a flux component content of any value between any of the minimum and maximum values noted above.

According to particular embodiments, the flame retardant component of the filler composition 120 may include particular components. For example, the flame retardant component may include a component selected from the group consisting of aluminum hydroxide, magnesium hydroxide, or any combination thereof. According to still other embodiments, the flame retardant component may include aluminum hydroxide. According to yet other embodiments, the flame retardant component may consist of aluminum hydroxide. According to still other embodiments, the flame retardant component may include magnesium hydroxide. According to yet other embodiments, the flame retardant component may consist of magnesium hydroxide.

According to still other embodiments, the filler composition 120 may include a particular content of the flame retardant component. For example, the filler composition 120 may include a flame retardant component content of at least about 5.0 wt. % for a total weight of the filler composition 120, such as, at least about 6.0 wt. % or at least about 7.0 wt. % or at least about 8.0 wt. % or at least about 9.0 wt. % or at least about 10.0 wt. % or at least about 11.0 wt. % or even at least about 12.0 wt. %. According to still other embodiments, the filler composition 120 may include a flame retardant component content of not greater than about 20.0 wt. % for a total weight of the filler composition 120, such as, not greater than about 19.0 wt. % or not greater than about 18.0 wt. % or not greater than about 17.0 wt. % or not greater than about 16.0 wt. % or not greater than about 15.0 wt. % or even not greater than about 14.0 wt. %. It will be appreciated that filler composition 120 may include a flame retardant component content of any value within a range between any of the minimum and maximum values noted above. It will be further appreciated that the filler composition 120 may include a flame retardant component content of any value between any of the minimum and maximum values noted above.

According to still other embodiments, the composite material 100 may include a particular content of the flame retardant component. For example, the composite material 100 may include a flame retardant component content of at least about 2.5 wt. % for a total weight of the composite material 100, such as, at least about 3.0 wt. % or at least about 3.5 wt. % or at least about 4.0 wt. % or at least about 4.5 wt. % or at least about 5.0 wt. % or at least about 5.5 wt. % or even at least about 6.0 wt. %. According to still other embodiments, the composite material 100 may include a flame retardant component content of not greater than about 18.0 wt. % for a total weight of the composite material 100, such as, not greater than about 17.5 wt. % or not greater than about 17.0 wt. % or not greater than about 16.5 wt. % or not greater than about 16.0 wt. % or not greater than about 15.5 wt. % or even not greater than about 15.0 wt. %. It will be appreciated that composite material 100 may include a flame retardant component content of any value within a range between any of the minimum and maximum values noted above. It will be further appreciated that the composite material 100 may include a flame retardant component content of any value between any of the minimum and maximum values noted above.

According to still other embodiments, the filler composition 120 may further include a functional additive. According to yet other embodiments, the functional additive may include a particular component. For example, the functional additive may include a component selected from the group consisting of iron (III) oxide, titanium oxide, or any combination thereof. According to still other embodiments, the functional additive component may include iron (III) oxide. According to yet other embodiments, the functional additive component may consist of iron (III) oxide. According to still other embodiments, the functional additive component may include titanium oxide. According to yet other embodiments, the functional additive component may consist of titanium oxide.

According to still other embodiments, the filler composition 120 may include a particular content of the functional additive. For example, the filler composition 120 may include a functional additive content of at least about 0.1 wt. % for a total weight of the filler composition 120, such as, at least about 0.5 wt. % or at least about 1.0 wt. % or at least about 1.5 wt. % or at least about 2.0 wt. % or at least about 2.5 wt. % or at least about 3.0 wt. % or even at least about 3.5 wt. %. According to still other embodiments, the filler composition 120 may include a functional additive content of not greater than about 7.0 wt. % for a total weight of the filler composition 120, such as, not greater than about 6.5 wt. % or not greater than about 6.0 wt. % or not greater than about 5.5 wt. % or not greater than about 5.0 wt. % or not greater than about 4.5 wt. % or even not greater than about 4.0 wt. %. It will be appreciated that filler composition 120 may include a functional additive content of any value within a range between any of the minimum and maximum values noted above. It will be further appreciated that the filler composition 120 may include a functional additive content of any value between any of the minimum and maximum values noted above.

According to still other embodiments, the composite material 100 may include a particular content of the functional additive. For example, the composite material 100 may include a functional additive content of at least about 0.05 wt. % for a total weight of the composite material 100, such as, at least about 0.1 wt. % or at least about 0.5 wt. % or at least about 1.0 wt. % or at least about 1.5 wt. % or at least about 2.0 wt. % or even at least about 2.5 wt. %. According to still other embodiments, the composite material 100 may include a functional additive content of not greater than about 6.5 wt. % for a total weight of the composite material 100, such as, not greater than about 6.0 wt. % or not greater than about 5.5 wt. % or not greater than about 5.0 wt. % or even not greater than about 4.5 wt. %. It will be appreciated that composite material 100 may include a functional additive content of any value within a range between any of the minimum and maximum values noted above. It will be further appreciated that the composite material 100 may include a functional additive content of any value between any of the minimum and maximum values noted above.

According to certain embodiments, the composite material 100 may have a particular flammability rating as measured according to ASTM D3801. In particular, the composite material 100 may have a V-O flammability rating as measured according to ASTM D3801.

According to still other embodiments, the composite material 100 may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material 100 may have a 5-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 5-minute HPE cold side temperature of at least about 25° C. It will be appreciated that the 5-minute HPE cold side temperature of the composite material 100 may be within a range between any of the values noted above. It will be further appreciated that the 5-minute HPE cold side temperature of the composite material 100 may be any value between any of the values noted above.

According to still other embodiments, the composite material 100 may have a particular 15-minute hot plate exposure (HPE) cold-side temperature as measured using a hot plate test conducted at 800° ° C. for 15 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material 100 may have a 15-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° ° C. According to still other embodiments, the composite material 100 may have a 15-minute HPE cold side temperature of at least about 25° C. It will be appreciated that the 15-minute HPE cold side temperature of the composite material 100 may be within a range between any of the values noted above. It will be further appreciated that the 15-minute HPE cold side temperature of the composite material 100 may be any value between any of the values noted above.

According to still other embodiments, the composite material 100 may have a particular 30-minute hot plate exposure (HPE) cold-side temperature as measured using a hot plate test conducted at 800° ° C. for 30 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. Then an infrared (IR) thermometer is used to measure the cold side surface temperature of the sample at the designated time. According to certain embodiments, the composite material 100 may have a 30-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 30-minute HPE cold side temperature of at least about 25° C. It will be appreciated that the 30-minute HPE cold side temperature of the composite material 100 may be within a range between any of the values noted above. It will be further appreciated that the 30-minute HPE cold side temperature of the composite material 100 may be any value between any of the values noted above.

According to still other embodiments, the composite material 100 may have a particular 5-minute torch exposure (TE) cold-side temperature as measured using a torch test conducted at 1500° C. for 5 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material 100 may have a 5-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 5-minute TE cold side temperature of at least about 25° C. It will be appreciated that the 5-minute TE cold side temperature of the composite material 100 may be within a range between any of the values noted above. It will be further appreciated that the 5-minute TE cold side temperature of the composite material 100 may be any value between any of the values noted above.

According to still other embodiments, the composite material 100 may have a particular 15-minute torch exposure (TE) cold-side temperature as measured using a torch test conducted at 1500° C. for 15 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. Then an infrared (IR) thermometer or a thermocouple is used to measure the cold side surface temperature of the sample at the designated time. According to certain embodiments, the composite material 100 may have a 15-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 15-minute TE cold side temperature of at least about 25° C. It will be appreciated that the 15-minute TE cold side temperature of the composite material 100 may be within a range between any of the values noted above. It will be further appreciated that the 15-minute TE cold side temperature of the composite material 100 may be any value between any of the values noted above.

According to still other embodiments, the composite material 100 may have a particular 30-minute torch exposure (TE) cold-side temperature as measured using a torch test conducted at 1500° ° C. for 30 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. Then an infrared (IR) thermometer or a thermocouple is used to measure the cold side surface temperature of the sample at the designated time. According to certain embodiments, the composite material 100 may have a 30-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material 100 may have a 30-minute TE cold side temperature of at least about 25° ° C. It will be appreciated that the 30-minute TE cold side temperature of the composite material 100 may be within a range between any of the values noted above. It will be further appreciated that the 30-minute TE cold side temperature of the composite material 100 may be any value between any of the values noted above.

According to yet other embodiments, the composite material 100 may have a particular density. For the purpose of embodiments described herein, the density of the composite material 100 may be determined according to ASTM D1056. According to certain embodiments, the composite material 100 may have a density of not greater than about 1.7 kg/m³, such as, not greater than about 1.6 kg/m³ or not greater than about 1.5 kg/m³ or not greater than about 1.4 kg/m³ or not greater than about 1.3 kg/m³ or not greater than about 1.2 kg/m³ or not greater than about 1.1 kg/m³ or not greater than about 1.0 kg/m³ or not greater than about 0.9 kg/m³ or not greater than about 0.8 kg/m³ or not greater than about 0.7 kg/m³ or not greater than about 0.6 kg/m³ or not greater than about 0.5 kg/m³ or even not greater than about 0.4 kg/m³. According to yet other embodiments, the composite material 100 may have a density of at least about 0.001 kg/m³. It will be appreciated that the density of the composite material 100 may be within a range between any of the minimum and maximum values noted above. It will be further appreciated that the density of the composite material 100 may be any value between any of the minimum and maximum values noted above.

According to yet other embodiments, the composite material 100 may have a particular weight. According to certain embodiments, the composite material 100 may have a weight of at least about 0.001 kg/m², such as, at least about 0.005 kg/m² or at least about 0.01 kg/m² or at least about 0.05 kg/m² or at least about 0.1 kg/m² or at least about 0.5 kg/m² or at least about 1.0 kg/m² or even at least about 1.5 kg/m². According to yet other embodiments, the composite material 100 may have a weight of not greater than about 2.61 kg/m². It will be appreciated that the weight of the composite material 100 may be within a range between any of the minimum and maximum values noted above. It will be further appreciated that the weight of the composite material 100 may be any value between any of the minimum and maximum values noted above.

According to yet other embodiments, the composite material 100 may have a particular hardness. For the purpose of embodiments described herein, the hardness of the composite material 100 may be determined according to D2240. According to certain embodiments, the composite material 100 may have a hardness of at least about 61 Shore A, such as, at least about 62 Shore A or at least about 63 Shore A or at least about 64 Shore A or even at least about 65 Shore A. According to yet other embodiments, the composite material 100 may have a hardness of not greater than about 71 Shore A, such as, not greater than about 70 Shore A or not greater than about 69 Shore A or not greater than about 68 Shore A or not greater than about 67 Shore A or even not greater than about 66 Shore A. It will be appreciated that the hardness of the composite material 100 may be within a range between any of the minimum and maximum values noted above. It will be further appreciated that the hardness of the composite material 100 may be any value between any of the minimum and maximum values noted above.

According to yet other embodiments, the composite material 100 may have a particular tensile strength. For the purpose of embodiments described herein, the tensile strength of the composite material 100 may be determined according to D412. According to certain embodiments, the composite material 100 may have a tensile strength of at least about 2.3 MPa, such as, at least about 2.5 MPa or at least about 5 MPa or at least about 10 MPa or at least about 20 MPa or at least about 30 MPa or at least about 40 MPa or at least about 50 MPa or at least about 100 MPa or even at least about 150 MPa. According to yet other embodiments, the composite material 100 may have a tensile strength of not greater than about 500 MPa. It will be appreciated that the tensile strength of the composite material 100 may be within a range between any of the minimum and maximum values noted above. It will be further appreciated that the tensile strength of the composite material 100 may be any value between any of the minimum and maximum values noted above.

Referring now to embodiments of the composite material layer, the composite material described herein may be formed as a layer of material. It will be appreciated that according to particular embodiments, a composite material layer described herein may include any of the components described herein with reference to the composite material 100. It will be further appreciated that according to particular embodiments, a composite material layer described herein may have any of the characteristics described herein with reference to the composite material 100.

According to yet other embodiments, the composite material layer may have a particular thickness. For example, the composite material layer may have a thickness of at least about 0.2 mm, such as, at least about 0.5 mm or at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the composite material layer may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the composite material layer may be within a range between any of the minimum and maximum values noted above. It will be further appreciated that the thickness of the composite material layer may be any value between any of the minimum and maximum values noted above.

According to certain embodiments, the composite material layer may have a particular flammability rating as measured according to ASTM D3801. In particular, the composite material layer may have a V-O flammability rating as measured according to ASTM D3801.

According to still other embodiments, the composite material layer may have a particular 5-minute hot plate exposure (HPE) cold-side temperature as measured using a hot plate test conducted at 800° C. for 5 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 5-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 5-minute HPE cold side temperature of at least about 25° C. It will be appreciated that the 5-minute HPE cold side temperature of the composite material layer may be within a range between any of the values noted above. It will be further appreciated that the 5-minute HPE cold side temperature of the composite material layer may be any value between any of the values noted above.

According to still other embodiments, the composite material layer may have a particular 15-minute hot plate exposure (HPE) cold-side temperature as measured using a hot plate test conducted at 800° C. for 15 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 15-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 15-minute HPE cold side temperature of at least about 25° C. It will be appreciated that the 15-minute HPE cold side temperature of the composite material layer may be within a range between any of the values noted above. It will be further appreciated that the 15-minute HPE cold side temperature of the composite material layer may be any value between any of the values noted above.

According to still other embodiments, the composite material layer may have a particular 30-minute hot plate exposure (HPE) cold-side temperature as measured using a hot plate test conducted at 800° C. for 30 minutes. For purposes of embodiments described herein, the hot plate test is carried out by preparing a 15 cm by 25 cm specimen of the composite material laminated onto a layer of alkaline free glass fabric having a thickness of 0.3 mm, such that the total specimen thickness is 1.5 mm. The specimen is placed on top of a hot plate adjusted to the desired temperature with the composite material side of the specimen facing the hot plate. An infrared (IR) thermometer is used to measure the temperature at the central point of the cold side surface (i.e., the side of the specimen opposite the hot plate) of the sample at the designated time. According to certain embodiments, the composite material layer may have a 30-minute HPE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 30-minute HPE cold side temperature of at least about 25° C. It will be appreciated that the 30-minute HPE cold side temperature of the composite material layer may be within a range between any of the values noted above. It will be further appreciated that the 30-minute HPE cold side temperature of the composite material layer may be any value between any of the values noted above.

According to still other embodiments, the composite material layer may have a particular 5-minute torch exposure (TE) cold-side temperature as measured using a torch test conducted at 1500° C. for 5 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material layer may have a 5-minute TE cold side temperature of not greater than about 800° C., such as, not greater than about 775° C. or not greater than about 750° ° C. or not greater than about 725° C. or not greater than about 700° C. or not greater than about 675° C. or not greater than about 650° C. or not greater than about 625° C. or even not greater than about 600° ° C. According to still other embodiments, the composite material layer may have a 5-minute TE cold side temperature of at least about 25° C. It will be appreciated that the 5-minute TE cold side temperature of the composite material layer may be within a range between any of the values noted above. It will be further appreciated that the 5-minute TE cold side temperature of the composite material layer may be any value between any of the values noted above.

According to still other embodiments, the composite material layer may have a particular 15-minute torch exposure (TE) cold-side temperature as measured using a torch test conducted at 1500° C. for 15 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. According to certain embodiments, the composite material layer may have a 15-minute TE cold side temperature of not greater than about 800° C., such as, not greater than about 775° C. or not greater than about 750° C. or not greater than about 725° C. or not greater than about 700° C. or not greater than about 675° C. or not greater than about 650° C. or not greater than about 625° C. or even not greater than about 600° C. According to still other embodiments, the composite material layer may have a 15-minute TE cold side temperature of at least about 25° C. It will be appreciated that the 15-minute TE cold side temperature of the composite material layer may be within a range between any of the values noted above. It will be further appreciated that the 15-minute TE cold side temperature of the composite material layer may be any value between any of the values noted above.

According to still other embodiments, the composite material layer may have a particular 30-minute torch exposure (TE) cold-side temperature as measured using a torch test conducted at 1500° C. for 30 minutes. For purposes of embodiments described herein, the torch test is carried out by preparing a 15 cm by 15 cm specimen of the composite material laminated onto a layer of alkaline free glass fabric having a thickness of 0.3 mm, such that the total specimen thickness is 1.5 mm. The specimen is fixed on a holder. A torch is placed 7 cm away from a face of the specimen fixed on the holder with the composite material side of the specimen facing the torch. The torch is adjusted to produce an outer flame just touching the central point of the composite material side of the specimen that reaches and is stabilized at a desired temperature as measured using a thermometer at a point where the flame touches the specimen. An infrared (IR) thermometer or a thermocouple is used to measure the temperature at the central point of the cold side surface (i.e., the side of the specimen opposite the torch) of the sample at the designated time. Then an infrared (IR) thermometer or a thermocouple is used to measure the cold side surface temperature of the sample at the designated time. According to certain embodiments, the composite material layer may have a 30-minute TE cold side temperature of not greater than about 800° C., such as, not greater than about 775° C. or not greater than about 750° C. or not greater than about 725° ° C. or not greater than about 700° C. or not greater than about 675° C. or not greater than about 650° C. or not greater than about 625° C. or even not greater than about 600° C. According to still other embodiments, the composite material layer may have a 30-minute TE cold side temperature of at least about 25° C. It will be appreciated that the 30-minute TE cold side temperature of the composite material layer may be within a range between any of the values noted above. It will be further appreciated that the 30-minute TE cold side temperature of the composite material layer may be any value between any of the values noted above.

According to yet other embodiments, the composite material layer may have a particular density. For the purpose of embodiments described herein, the density of the composite material layer may be determined according to ASTM D1056. According to certain embodiments, the composite material layer may have a density of not greater than about 1.7 kg/m³, such as, not greater than about 1.6 kg/m³ or not greater than about 1.5 kg/m³ or not greater than about 1.4 kg/m³ or not greater than about 1.3 kg/m³ or not greater than about 1.2 kg/m³ or not greater than about 1.1 kg/m³ or not greater than about 1.0 kg/m³ or not greater than about 0.9 kg/m³ or not greater than about 0.8 kg/m³ or not greater than about 0.7 kg/m³ or not greater than about 0.6 kg/m³ or not greater than about 0.5 kg/m³ or even not greater than about 0.4 kg/m³. According to yet other embodiments, the composite material layer may have a density of at least about 0.001 kg/m³. It will be appreciated that the density of the composite material layer may be within a range between any of the minimum and maximum values noted above. It will be further appreciated that the density of the composite material layer may be any value between any of the minimum and maximum values noted above.

According to yet other embodiments, the composite material layer may have a particular weight. According to certain embodiments, the composite material layer may have a weight of at least about 0.001 kg/m², such as, at least about 0.005 kg/m² or at least about 0.01 kg/m² or at least about 0.05 kg/m² or at least about 0.1 kg/m² or at least about 0.5 kg/m² or at least about 1.0 kg/m² or even at least about 1.5 kg/m². According to yet other embodiments, the composite material layer may have a weight of not greater than about 2.61 kg/m². It will be appreciated that the weight of the composite material layer may be within a range between any of the minimum and maximum values noted above. It will be further appreciated that the weight of the composite material layer may be any value between any of the minimum and maximum values noted above.

According to yet other embodiments, the composite material layer may have a particular hardness. For the purpose of embodiments described herein, the hardness of the composite material layer may be determined according to ASTM D2240. According to certain embodiments, the composite material layer may have a hardness of at least about 61 Shore A, such as, at least about 62 Shore A or at least about 63 Shore A or at least about 64 Shore A or even at least about 65 Shore A. According to yet other embodiments, the composite material layer may have a hardness of not greater than about 81 Shore A, such as, not greater than about 80 Shore A or not greater than about 79 Shore A or not greater than about 78 Shore A or not greater than about 77 Shore A or not greater than about 76 Shore A or not greater than about 75 Shore A or not greater than about 74 Shore A or not greater than about 73 Shore A or not greater than about 72 Shore A or not greater than about 71 Shore A or not greater than about 70 Shore A or not greater than about 69 Shore A or not greater than about 68 Shore A or not greater than about 67 Shore A or even not greater than about 66 Shore A. It will be appreciated that the hardness of the composite material layer may be within a range between any of the minimum and maximum values noted above. It will be further appreciated that the hardness of the composite material layer may be any value between any of the minimum and maximum values noted above.

According to yet other embodiments, the composite material layer may have a particular tensile strength. For the purpose of embodiments described herein, the tensile strength of the composite material layer may be determined according to ASTM D412. According to certain embodiments, the composite material layer may have a tensile strength of at least about 2.3 MPa, such as, at least about 2.5 MPa or at least about 5 MPa or at least about 10 MPa or at least about 20 MPa or at least about 30 MPa or at least about 40 MPa or at least about 50 MPa or at least about 100 MPa or even at least about 150 MPa. According to yet other embodiments, the composite material layer may have a tensile strength of not greater than about 500 MPa. It will be appreciated that the tensile strength of the composite material layer may be within a range between any of the minimum and maximum values noted above. It will be further appreciated that the tensile strength of the composite material layer may be any value between any of the minimum and maximum values noted above.

According to certain embodiments, composite material layers described herein may be formed according to any acceptable forming process for a composite material layer.

Tuning now to additional embodiments described herein, such embodiments are generally directed to a thermal barrier composite that may include a composite material or a composite material layer as described herein. It will be appreciated that according to particular embodiments, a thermal barrier composite described herein may include any of the components described herein with reference to the composite material 100. It will be further appreciated that according to particular embodiments, a thermal barrier composite described herein may have any of the characteristics described herein with reference to the composite material 100.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A filler composition comprising: a ceramization filler component at a content of at least about 50 wt. % and not greater than about 90 wt. % for a total weight of the filler composition, a reinforcement component at a content of at least about 0.1 wt. % and not greater than about 10.0 wt. % for a total weight of the filler composition, a flux component at a content of at least about 3.0 wt. % and not greater than about 10.0 wt. % for a total weight of the filler composition, and a flame retardant component at least about 5.0 wt. % and not greater than about 20 wt. % for a total weight of the filler composition.

Embodiment 2. A composite material comprising: a polymer-based matrix component, and a filler composition distributed within the polymer-based component, wherein the filler composition comprises: a ceramization filler component, a reinforcement component, a flux component, and a flame retardant component.

Embodiment 3. A composite material layer comprising: a polymer-based matrix component, and a filler composition distributed within the polymer-based component, wherein the filler composition comprises: a ceramization filler component, a reinforcement component, a flux component, and a flame retardant component.

Embodiment 4. The composite material or composite material layer of any one of embodiments 2, and 3, wherein the composite material or composite material layer comprises a 5-minute HPE cold side temperature of not greater than about 800° C. as measured after 5 minutes of a hotplate test conducted at 800° C.

Embodiment 5. The composite material or composite material layer of any one of embodiments 2, and 3, wherein the composite material or composite material layer comprises a 15-minute HPE cold side temperature of not greater than about 800° C. as measured after 15 minutes of a hotplate test conducted at 800° C.

Embodiment 6. The composite material or composite material layer of any one of embodiments 2, and 3, wherein the composite material or composite material layer comprises a 30-minute HPE cold side temperature of not greater than about 800° C. as measured after 30 minutes of a hotplate test conducted at 800° ° C.

Embodiment 7. The composite material or composite material layer of any one of embodiments 2, and 3, wherein the composite material or composite material layer comprises a 5-minute TE cold side temperature of not greater than about 800° C. as measured at 5 minutes of a torch test conducted at 1500° C.

Embodiment 8. The composite material or composite material layer of any one of embodiments 2, and 3, wherein the composite material or composite material layer comprises a 15-minute TE cold side temperature of not greater than about 800° C. as measured at 15 minutes of a torch test conducted at 1500° C.

Embodiment 9. The composite material or composite material layer of any one of embodiments 2, and 3, wherein the composite material or composite material layer comprises a 30-minute TE cold side temperature of not greater than about 800° C. as measured at 30 minutes of a torch test conducted at 1500° C.

Embodiment 10. The composite material or composite material layer of any one of embodiments 2, and 3, wherein the composite material or composite material layer comprises a V-0 flammability rating as measured according to ASTM D3801.

Embodiment 11. The composite material or composite material layer of any one of embodiments 2, and 3, wherein the polymer-based component comprises a component selected from the group consisting of silicone, polyurethane, epoxy, acrylic resin, or any combination thereof.

Embodiment 12. The composite material or composite material layer of any one of embodiments 2, and 3, wherein the composite material comprises a polymer-based component content of at least about 30 wt. % for a total weight of the composite material.

Embodiment 13. The composite material or composite material layer of any one of embodiments 2, and 3, wherein the composite material comprises a polymer-based component content of not greater than about 60 wt. % for a total weight of the composite material.

Embodiment 14. The composite material or composite material layer of any one of embodiments 2, and 3, wherein the composite material comprises a filler composition content of at least about 40 wt. % for a total weight of the composite material.

Embodiment 15. The composite material or composite material layer of any one of embodiments 2, and 3, wherein the composite material comprises a filler composition content of not greater than about 70 wt. % for a total weight of the composite material.

Embodiment 16. The composite material or composite material layer of any one of embodiments 1, 2, and 3, wherein the ceramization filler component comprises a component selected from the group consisting of aluminum silicate, zirconium silicate, zirconia, alumina, or any combination thereof.

Embodiment 17. The composite material or composite material layer of any one of embodiments 1, 2, and 3, wherein the filler composition comprises a ceramization filler component content of at least about 50 wt. % for a total weight of the filler composition.

Embodiment 18. The composite material or composite material layer of any one of embodiments 1, 2, and 3, wherein the filler composition comprises a ceramization filler component content of not greater than about 90 wt. % for a total weight of the filler composition.

Embodiment 19. The composite material or composite material layer of any one of embodiments 2, and 3, wherein the filler composition comprises a ceramization filler component content of at least about 25 wt. % for a total weight of the composite material.

Embodiment 20. The composite material or composite material layer of any one of embodiments 2, and 3, wherein the filler composition comprises a ceramization filler component content of not greater than about 65 wt. % for a total weight of the composite material.

Embodiment 21. The composite material or composite material layer of any one of embodiments 1, 2, and 3, wherein the reinforcement component comprises a component selected from the group consisting of wollastonite, sepiolite, or any combination thereof.

Embodiment 22. The composite material or composite material layer of any one of embodiments 1, 2, and 3, wherein the filler composition comprises a reinforcement component content of at least about 0.1 wt. % for a total weight of the filler composition.

Embodiment 23. The composite material or composite material layer of any one of embodiments 1, 2, and 3, wherein the filler composition comprises a reinforcement component content of not greater than about 10.0 wt. % for a total weight of the filler composition.

Embodiment 24. The composite material or composite material layer of any one of embodiments 2, and 3, wherein the filler composition comprises a reinforcement component content of at least about 0.05 wt. % for a total weight of the composite material.

Embodiment 25. The composite material or composite material layer of any one of embodiments 2, and 3, wherein the filler composition comprises a reinforcement component content of not greater than about 9.0 wt. % for a total weight of the composite material.

Embodiment 26. The composite material or composite material layer of any one of embodiments 1, 2, and 3, wherein the flux component comprises a component selected from the group consisting of low T glass frit, zinc oxide, zinc borate, antimony (III) oxide, bismuth (III) oxide, or any combination thereof.

Embodiment 27. The composite material or composite material layer of any one of embodiments 1, 2, and 3, wherein the filler composition comprises a flux component content of at least about 3 wt. % for a total weight of the filler composition.

Embodiment 28. The composite material or composite material layer of any one of embodiments 1, 2, and 3, wherein the filler composition comprises a flux component content of not greater than about 10.0 wt. % for a total weight of the filler composition.

Embodiment 29. The composite material or composite material layer of any one of embodiments 2, and 3, wherein the filler composition comprises a flux component content of at least about 1.5 wt. % for a total weight of the composite material.

Embodiment 30. The composite material or composite material layer of any one of embodiments 2, and 3, wherein the filler composition comprises a flux component content of not greater than about 9.0 wt. % for a total weight of the composite material.

Embodiment 31. The composite material or composite material layer of any one of embodiments 1, 2, and 3, wherein the flame retardant component comprises a component selected from the group consisting of aluminum hydroxide, magnesium hydroxide, or any combination thereof.

Embodiment 32. The composite material or composite material layer of any one of embodiments 1, 2, and 3, wherein the filler composition comprises a flame retardant component content of at least about 5.0 wt. % for a total weight of the filler composition.

Embodiment 33. The composite material or composite material layer of any one of embodiments 1, 2, and 3, wherein the filler composition comprises a flame retardant component content of not greater than about 20.0 wt. % for a total weight of the filler composition.

Embodiment 34. The composite material or composite material layer of any one of embodiments 2, and 3, wherein the filler composition comprises a flame retardant component content of at least about 2.5 wt. % for a total weight of the composite material.

Embodiment 35. The composite material or composite material layer of any one of embodiments 2, and 3, wherein the filler composition comprises a flame retardant component content of not greater than 18.0 wt. % for a total weight of the composite material.

Embodiment 36. The composite material or composite material layer of any one of embodiments 1, 2, and 3, wherein the filler composition further comprises a functional additive.

Embodiment 37. The composite material or composite material layer of embodiment 36, wherein the functional additive comprises a component selected from the group consisting of iron (III) oxide, titanium oxide, or any combination thereof.

Embodiment 38. The composite material or composite material layer of embodiment 36, wherein the filler composition comprises a functional additive content of at least about 0.1 wt. % for a total weight of the filler composition.

Embodiment 39. The composite material or composite material layer of embodiment 36, wherein the filler composition comprises a functional additive content of not greater than about 7.0 wt. % for a total weight of the filler composition.

Embodiment 40. The composite material or composite material layer of embodiment 36, wherein the filler composition comprises a functional additive content of at least about 0.05 wt. % for a total weight of the composite material.

Embodiment 41. The composite material or composite material layer of embodiment 36, wherein the filler composition comprises a functional additive content of not greater than about 6.5 wt. % for a total weight of the composite material.

Embodiment 42. The composite material layer of embodiment 3, wherein the material layer comprises a thickness of at least about 0.2 mm.

Embodiment 43. The composite material layer of embodiment 3, wherein the material layer comprises a thickness of not greater than about 3.0 mm.

Embodiment 44. The composite material layer of embodiment 2, wherein the composite material comprises a density of not greater than about 1.7 kg/m³.

Embodiment 45. The composite material layer of embodiment 2, wherein the composite material comprises a density of at least about 0.001 kg/m³.

Embodiment 46. The composite material layer of embodiment 3, wherein the material layer comprises a density of not greater than about 1.7 kg/m³.

Embodiment 47. The composite material layer of embodiment 3, wherein the material layer comprises a density of at least about 0.001 kg/m³.

Embodiment 48. The composite material layer of embodiment 2, wherein the composite material comprises a weight of at least about 0.001 kg/m².

Embodiment 49. The composite material layer of embodiment 2, wherein the composite material comprises a weight of not greater than about 2.61 kg/m².

Embodiment 50. The composite material layer of embodiment 3, wherein the material layer comprises a weight of at least about 0.001 kg/m².

Embodiment 51. The composite material layer of embodiment 3, wherein the material layer comprises a weight of not greater than about 2.61 kg/m².

Embodiment 52. The composite material layer of embodiment 2, wherein the composite material comprises a hardness of at least about 61 Shore A.

Embodiment 53. The composite material layer of embodiment 2, wherein the composite material comprises a hardness of not greater than about 71 Shore A.

Embodiment 54. The composite material layer of embodiment 3, wherein the material layer comprises a hardness of at least about 61 Shore A.

Embodiment 55. The composite material layer of embodiment 3, wherein the material layer comprises a hardness of not greater than about 71 Shore A.

Embodiment 56. The composite material layer of embodiment 2, wherein the composite material comprises a tensile strength of at least about 2.3 MPa.

Embodiment 57. The composite material layer of embodiment 2, wherein the composite material comprises a tensile strength of not greater than about 500 MPa.

Embodiment 58. The composite material layer of embodiment 3, wherein the material layer comprises a tensile strength of at least about 10 MPa.

Embodiment 59. The composite material layer of embodiment 3, wherein the material layer comprises a tensile strength of not greater than about 500 MPa.

Embodiment 60. A thermal barrier composite comprising a composite material, wherein the composite material comprises: a polymer-based matrix component, and a filler composition distributed within the polymer-based component, wherein the filler composition comprises: a ceramization filler component, a structure promoter component, a flux component, and a flame retardant component.

Embodiment 61. A thermal barrier composite comprising a composite material layer, wherein the composite material layer comprises: a polymer-based matrix component, and a filler composition distributed within the polymer-based component, wherein the filler composition comprises: a ceramization filler component, a structure promoter component, a flux component, and a flame retardant component.

Embodiment 62. The thermal barrier composite of any one of embodiments 60, and 61, wherein the composite material or composite material layer comprises a 5-minute HPE cold side temperature of not greater than about 800° C. as measured after 5 minutes of a hotplate test conducted at 800° C.

Embodiment 63. The thermal barrier composite of any one of embodiments 60, and 61, wherein the composite material or composite material layer comprises a 15-minute HPE cold side temperature of not greater than about 800° C. as measured after 15 minutes of a hotplate test conducted at 800° ° C.

Embodiment 64. The thermal barrier composite of any one of embodiments 60, and 61, wherein the composite material or composite material layer comprises a 30-minute HPE cold side temperature of not greater than about 800° C. as measured after 30 minutes of a hotplate test conducted at 800° C.

Embodiment 65. The thermal barrier composite of any one of embodiments 60, and 61, wherein the composite material or composite material layer comprises a 5-minute TE cold side temperature of not greater than about 800° C. as measured at 5 minutes of a torch test conducted at 1500° C.

Embodiment 66. The thermal barrier composite of any one of embodiments 60, and 61, wherein the composite material or composite material layer comprises a 15-minute TE cold side temperature of not greater than about 800° C. as measured at 15 minutes of a torch test conducted at 1500° C.

Embodiment 67. The thermal barrier composite of any one of embodiments 60, and 61, wherein the composite material or composite material layer comprises a 15-minute TE cold side temperature of not greater than about 800° C. as measured at 15 minutes of a torch test conducted at 1500° C.

Embodiment 68. The thermal barrier composite of any one of embodiments 60, and 61, wherein the composite material or composite material layer comprises a V-O flammability rating as measured according to ASTM D3801.

Embodiment 69. The thermal barrier composite of any one of embodiments 60, and 61, wherein the polymer-based component comprises a component selected from the group consisting of silicone, polyurethane, epoxy, acrylic resin, or any combination thereof.

Embodiment 70. The thermal barrier composite of any one of embodiments 60, and 61, wherein the composite material comprises a polymer-based component content of at least about 30 wt. % for a total weight of the composite material.

Embodiment 71. The thermal barrier composite of any one of embodiments 60, and 61, wherein the composite material comprises a polymer-based component content of not greater than about 60 wt. % for a total weight of the composite material.

Embodiment 72. The thermal barrier composite of any one of embodiments 60, and 61, wherein the composite material comprises a filler composition content of at least about 40 wt. % for a total weight of the composite material.

Embodiment 73. The thermal barrier composite of any one of embodiments 60, and 61, wherein the composite material comprises a filler composition content of not greater than about 70 wt. % for a total weight of the composite material.

Embodiment 74. The thermal barrier composite of any one of embodiments 60, and 61, wherein the ceramization filler component comprises a component selected from the group consisting of aluminum silicate, zirconium silicate, zirconia, alumina, or any combination thereof.

Embodiment 75. The thermal barrier composite of any one of embodiments 60, and 61, wherein the filler composition comprises a ceramization filler component content of at least about 50 wt. % for a total weight of the filler composition.

Embodiment 76. The thermal barrier composite of any one of embodiments 60, and 61, wherein the filler composition comprises a ceramization filler component content of not greater than about 90 wt. % for a total weight of the filler composition.

Embodiment 77. The thermal barrier composite of any one of embodiments 60, and 61, wherein the filler composition comprises a ceramization filler component content of at least about 25 wt. % for a total weight of the composite material.

Embodiment 78. The thermal barrier composite of any one of embodiments 60, and 61, wherein the filler composition comprises a ceramization filler component content of not greater than about 65 wt. % for a total weight of the composite material.

Embodiment 79. The thermal barrier composite of any one of embodiments 60, and 61, wherein the reinforcement component comprises a component selected from the group consisting of wollastonite, or any combination thereof.

Embodiment 80. The thermal barrier composite of any one of embodiments 60, and 61, wherein the filler composition comprises a reinforcement component content of at least about 0.1 wt. % for a total weight of the filler composition.

Embodiment 81. The thermal barrier composite of any one of embodiments 60, and 61, wherein the filler composition comprises a reinforcement component content of not greater than about 10.0 wt. % for a total weight of the filler composition.

Embodiment 82. The thermal barrier composite of any one of embodiments 60, and 61, wherein the filler composition comprises a reinforcement component content of at least about 0.05 wt. % for a total weight of the composite material.

Embodiment 83. The thermal barrier composite of any one of embodiments 60, and 61, wherein the filler composition comprises a reinforcement component content of not greater than about 9.0 wt. % for a total weight of the composite material.

Embodiment 84. The thermal barrier composite layer of any one of embodiments 60, and 61, wherein the flux component comprises a component selected from the group consisting of low T glass frit, zinc oxide, zinc borate, antimony (III) oxide, bismuth (III) oxide, or any combination thereof.

Embodiment 85. The thermal barrier composite of any one of embodiments 60, and 61, wherein the filler composition comprises a flux component content of at least about 3 wt. % for a total weight of the filler composition.

Embodiment 86. The thermal barrier composite of any one of embodiments 60, and 61, wherein the filler composition comprises a flux component content of not greater than about 10.0 wt. % for a total weight of the filler composition.

Embodiment 87. The thermal barrier composite of any one of embodiments 60, and 61, wherein the filler composition comprises a flux component content of at least about 1.5 wt. % for a total weight of the composite material.

Embodiment 88. The thermal barrier composite of any one of embodiments 60, and 61, wherein the filler composition comprises a flux component content of not greater than about 9.0 wt. % for a total weight of the composite material.

Embodiment 89. The thermal barrier composite of any one of embodiments 60, and 61, wherein the flame retardant component comprises a component selected from the group consisting of aluminum hydroxide, magnesium hydroxide, or any combination thereof.

Embodiment 90. The thermal barrier composite of any one of embodiments 60, and 61, wherein the filler composition comprises a flame retardant component content of at least about 5.0 wt. % for a total weight of the filler composition.

Embodiment 91. The thermal barrier composite of any one of embodiments 60, and 61, wherein the filler composition comprises a flame retardant component content of not greater than about 20.0 wt. % for a total weight of the filler composition.

Embodiment 92. The thermal barrier composite of any one of embodiments 60, and 61, wherein the filler composition comprises a flame retardant component content of at least about 2.5 wt. % for a total weight of the composite material.

Embodiment 93. The thermal barrier composite of any one of embodiments 60, and 61, wherein the filler composition comprises a flame retardant component content of not greater than 18.0 wt. % for a total weight of the composite material.

Embodiment 94. The thermal barrier composite of any one of embodiments 60, and 61, wherein the filler composition further comprises a functional additive.

Embodiment 95. The thermal barrier composite of embodiment 94, wherein the functional additive comprises a component selected from the group consisting of iron (III) oxide, titanium oxide, or any combination thereof.

Embodiment 96. The thermal barrier composite of embodiment 94, wherein the filler composition comprises a functional additive content of at least about 0.1 wt. % for a total weight of the filler composition.

Embodiment 97. The thermal barrier composite of embodiment 94, wherein the filler composition comprises a functional additive content of not greater than about 7.0 wt. % for a total weight of the filler composition.

Embodiment 98. The thermal barrier composite of embodiment 94, wherein the filler composition comprises a functional additive content of at least about 0.05 wt. % for a total weight of the composite material.

Embodiment 99. The thermal barrier composite of embodiment 94, wherein the filler composition comprises a functional additive content of not greater than about 6.5 wt. % for a total weight of the composite material.

Embodiment 100. The thermal barrier composite of embodiment 61, wherein the material layer comprises a thickness of at least about 0.2 mm.

Embodiment 101. The thermal barrier composite embodiment 61, wherein the material layer comprises a thickness of not greater than about 3.0 mm.

Embodiment 102. The thermal barrier composite of embodiment 60, wherein the composite material comprises a density of not greater than about 1.7 kg/m³.

Embodiment 103. The thermal barrier composite of embodiment 60, wherein the composite material comprises a density of at least about 0.001 kg/m³.

Embodiment 104. The thermal barrier composite of embodiment 61, wherein the material layer comprises a density of not greater than about 1.7 kg/m³.

Embodiment 105. The thermal barrier composite of embodiment 61, wherein the material layer comprises a density of at least about 0.001 kg/m³.

Embodiment 106. The thermal barrier composite of embodiment 60, wherein the composite material comprises a weight of at least about 0.001 kg/m³.

Embodiment 107. The thermal barrier composite of embodiment 60, wherein the composite material comprises a weight of not greater than about 2.61 kg/m².

Embodiment 108. The thermal barrier composite of embodiment 61, wherein the material layer comprises a weight of at least about 0.001 kg/m².

Embodiment 109. The thermal barrier composite of embodiment 61, wherein the material layer comprises a weight of not greater than about 2.61 kg/m².

Embodiment 110. The thermal barrier composite of embodiment 60, wherein the composite material comprises a hardness of at least about 61 Shore A.

Embodiment 111. The thermal barrier composite of embodiment 60, wherein the composite material comprises a hardness of not greater than about 71 Shore A.

Embodiment 112. The thermal barrier composite of embodiment 61, wherein the material layer comprises a hardness of at least about 61 Shore A.

Embodiment 113. The thermal barrier composite of embodiment 61, wherein the material layer comprises a hardness of not greater than about 71 Shore A.

Embodiment 114. The thermal barrier composite of embodiment 60, wherein the composite material comprises a tensile strength of at least about 2.3 MPa.

Embodiment 115. The thermal barrier composite of embodiment 60, wherein the composite material comprises a tensile strength of not greater than about 500 MPa.

Embodiment 116. The thermal barrier composite of embodiment 61, wherein the material layer comprises a tensile strength of at least about 10 MPa.

Embodiment 117. The thermal barrier composite of embodiment 61, wherein the material layer comprises a tensile strength of not greater than about 500 MPa.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A filler composition comprising:
a ceramization filler component at a content of at least about 50 wt. % and not greater than about 90 wt. % for a total weight of the filler composition,
a reinforcement component at a content of at least about 0.1 wt. % and not greater than about 10.0 wt. % for a total weight of the filler composition,
a flux component at a content of at least about 3.0 wt. % and not greater than about 10.0 wt. % for a total weight of the filler composition, and
a flame retardant component at least about 5.0 wt. % and not greater than about 20 wt. % for a total weight of the filler composition.

2. A composite material comprising:
a polymer-based matrix component, and
a filler composition distributed within the polymer-based component,
wherein the filler composition comprises:
a ceramization filler component,
a reinforcement component,
a flux component, and
a flame retardant component.

3. The composite material of claim 2, wherein the composite material or composite material layer comprises a 5-minute HPE cold side temperature of not greater than about 800° C. as measured after 5 minutes of a hotplate test conducted at 800° C.

4. The composite material of claim 2, wherein the composite material or composite material layer comprises a 15-minute HPE cold side temperature of not greater than about 800° C. as measured after 15 minutes of a hotplate test conducted at 800° C.

5. The composite material of claim 2, wherein the composite material or composite material layer comprises a 30-minute HPE cold side temperature of not greater than about 800° C. as measured after 30 minutes of a hotplate test conducted at 800° C.

6. The composite material of claim 2, wherein the composite material or composite material layer comprises a 5-minute TE cold side temperature of not greater than about 800° C. as measured at 5 minutes of a torch test conducted at 1500° C.

7. The composite material of claim 2, wherein the composite material or composite material layer comprises a 15-minute TE cold side temperature of not greater than about 800° C. as measured at 15 minutes of a torch test conducted at 1500° C.

8. The composite material of claim 2, wherein the composite material or composite material layer comprises a 30-minute TE cold side temperature of not greater than about 800° C. as measured at 30 minutes of a torch test conducted at 1500° C.

9. The composite material of claim 2, wherein the composite material or composite material layer comprises a V-O flammability rating as measured according to ASTM D3801.

10. The composite material of claim 2, wherein the polymer-based component comprises a component selected from the group consisting of silicone, polyurethane, epoxy, acrylic resin, or any combination thereof.

11. The composite material of claim 2, wherein the composite material comprises a polymer-based component content of at least about 30 wt. % for a total weight of the composite material.

12. The composite material of claim 2, wherein the composite material comprises a polymer-based component content of not greater than about 60 wt. % for a total weight of the composite material.

13. A thermal barrier composite comprising a composite material layer, wherein the composite material layer comprises: a polymer-based matrix component, and a filler composition distributed within the polymer-based component, wherein the filler composition comprises: a ceramization filler component, a structure promoter component, a flux component, and a flame retardant component.

14. The thermal barrier composite of claim 13, wherein the composite material or composite material layer comprises a 5-minute HPE cold side temperature of not greater than about 800° C. as measured after 5 minutes of a hotplate test conducted at 800° C.

15. The thermal barrier composite of claim 13, wherein the composite material or composite material layer comprises a 15-minute HPE cold side temperature of not greater than about 800° ° C. as measured after 15 minutes of a hotplate test conducted at 800° C.

16. The thermal barrier composite of claim 13, wherein the composite material or composite material layer comprises a 30-minute HPE cold side temperature of not greater than about 800° C. as measured after 30 minutes of a hotplate test conducted at 800° ° C.

17. The thermal barrier composite of claim 13, wherein the composite material or composite material layer comprises a 5-minute TE cold side temperature of not greater than about 800° C. as measured at 5 minutes of a torch test conducted at 1500° C.

18. The thermal barrier composite of claim 13, wherein the composite material or composite material layer comprises a 15-minute TE cold side temperature of not greater than about 800° C. as measured at 15 minutes of a torch test conducted at 1500° C.

19. The thermal barrier composite of claim 13, wherein the composite material or composite material layer comprises a 15-minute TE cold side temperature of not greater than about 800° C. as measured at 15 minutes of a torch test conducted at 1500° C.

20. The thermal barrier composite of claim 13, wherein the composite material or composite material layer comprises a V-O flammability rating as measured according to ASTM D3801.
